(19) United States
(12) Patent Application Publication
(10) Pub. No.: US 2018/0361946 A1
(43) Pub. Date: Dec. 20, 2018

(54) Forward Facing Lane Car Camera

(71) Applicant: Keegan John Henry, Charleston, SC (US)

(72) Inventor: Keegan John Henry, Charleston, SC (US)

(21) Appl. No.: 15/530,691

(22) Filed: Feb. 10, 2016

(51) Int. Cl. B60R 11/04; B60R 1/00

(52) U.S. Cl. CPC B60R 11/04; B60R 1/00; B60R 2001/1253; B60R 2300/802; B60R 2300/804

(57) ABSTRACT

The Forward Facing Lane Car Camera is designed to enable the driver to see farther down the road without swerving or leaning inside the car to see around the car(s) in front of them. There is a camera on either, or both, mirror facing forward, which can be activated inside the car by the driver at any time.

This claim is in reference to previously filed U.S. application Ser. No. 15/530,691 on Feb. 10, 2016 with the application name of Keegan John Henry. This is a regional patent filed in the United States of America.

I, Keegan John Henry, have invented a new safety feature for automobiles called the Forward Facing Lane Car Camera. The purpose of this invention is to enable the driver to see around objects obstructing his or her view to the front. The Camera will be activated from a button inside the car, the camera, on each (or one) mirror, will then be activated, displaying what is ahead on the car's navigation system. Having this invention will prevent cars from swerving into neighboring lanes to see around a larger vehicle in front of them. See the included diagrams for a visual representation.

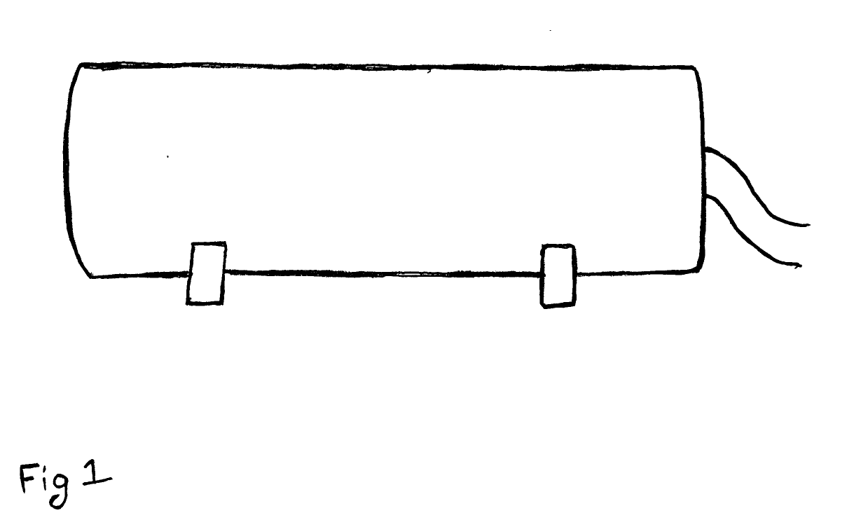

FIG. 1 is what the side of the camera will look like. The feet on the bottom of the camera will be the “top” of the camera as it will be attached to the mirror at that spot, upside-down.

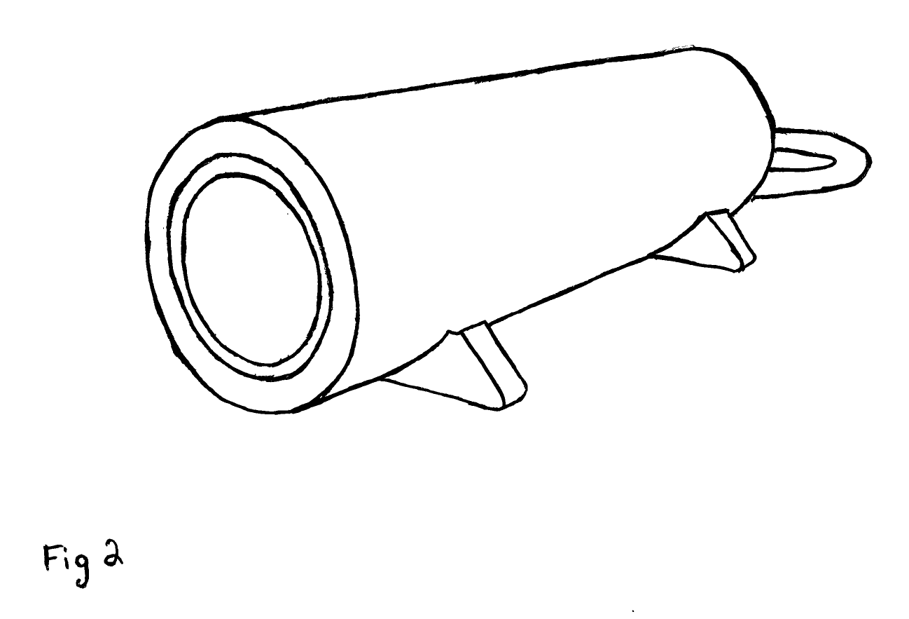

FIG. 2 is an angled view of the same camera, depicting what the lens would look like.

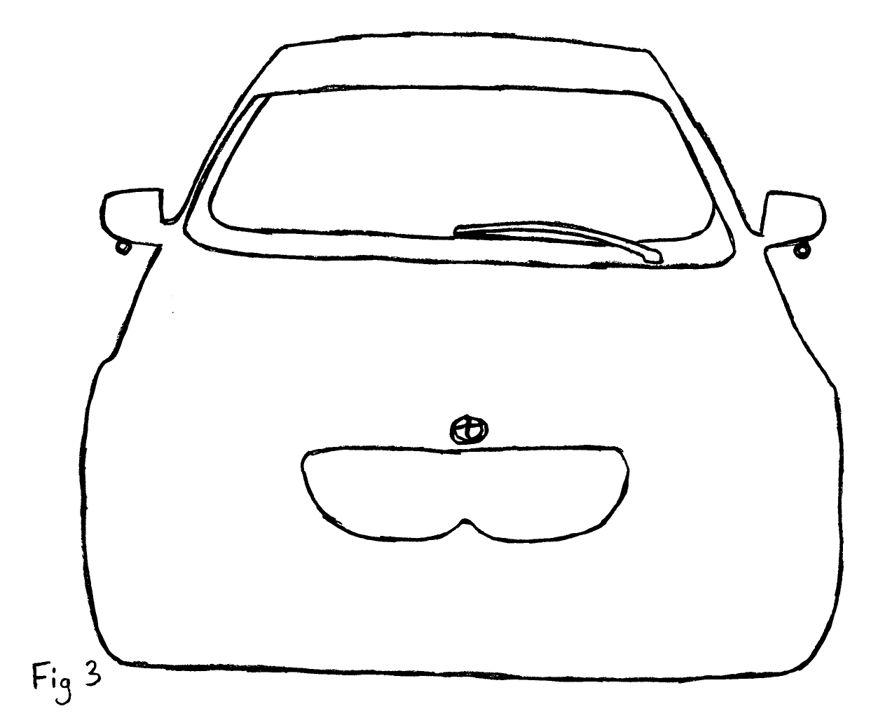

FIG. 3 is the front view of any given car, depicting what the car might look like with the side cameras attached to the mirrors. Both camera's do not have to be used, but there should be one button on the inside for each camera.

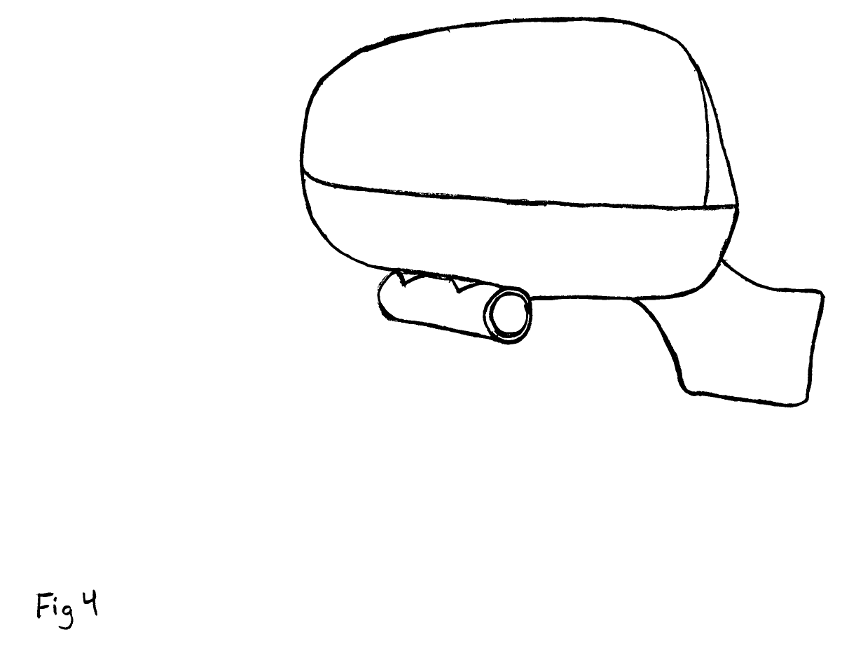

FIG. 4 is a close-up view of how the camera will be attached to the mirror.

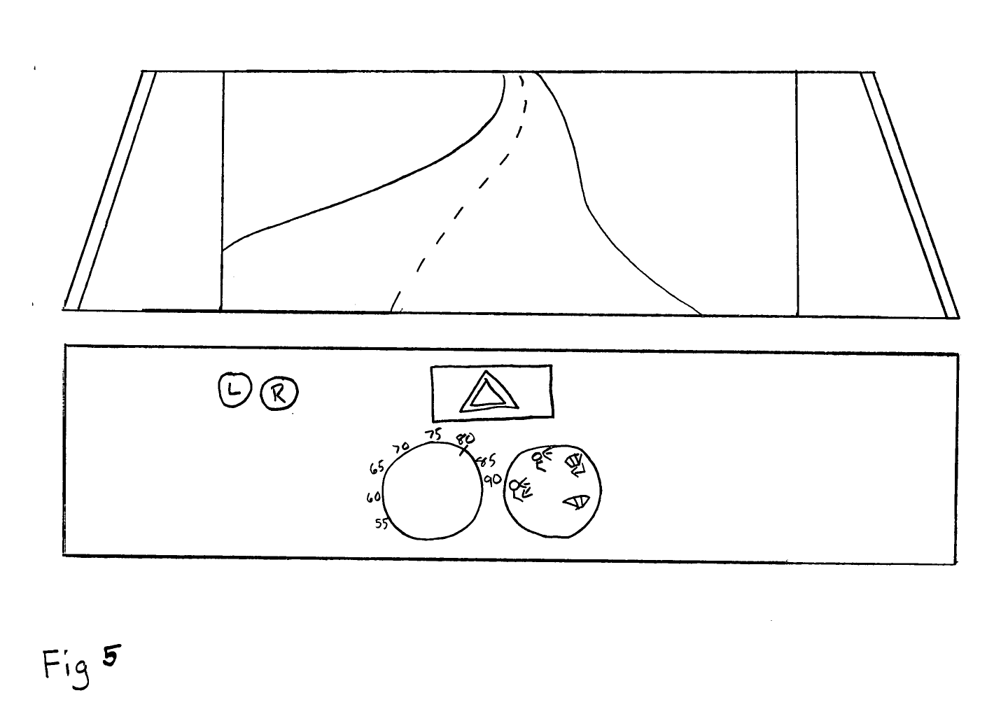

FIG. 5 is the inside dash view of what the car's navigation system could look like when the camera is activated. The buttons towards the left are the buttons used to activate the left, or right, camera. The buttons can be moved based on a manufactures specification, but are shown here for a visual representation.

I claim:

1. The ornamental design for The Forward Facing Lane Car Camera as shown and described.
